(19) United States
(12) Patent Application Publication
(10) Pub. No.: US 2015/0173334 A1
(43) Pub. Date: Jun. 25, 2015

(54) REINFORCED HYDROGEL LURES AND BAIT

(71) Applicant: UNIVERSITY OF FLORIDA RESEARCH FOUNDATION, INC., GAINESVILLE, FL (US)

(72) Inventors: Wallace Gregory Sawyer, Gainesville, FL (US); Thomas Ettore Angelini, Gainesville, FL (US); William R. Niederhauser, Kenai, AK (US); William W. Sawyer, Gainesville, FL (US); Charlie G. Sawyer, Gainesville, FL (US); Wallace C. Sawyer, Tampa, FL (US)

(73) Assignee: UNIVERSITY OF FLORIDA RESEARCH FOUNDATION, INC., GAINESVILLE, FL (US)

(21) Appl. No.: 14/415,021

(22) PCT Filed: Jul. 16, 2013
(86) PCT No.: PCT/US2013/050675

§ 371 Date: Jan. 15, 2015

Related U.S. Application Data
(60) Provisional application No. 61/672,163, filed on Jul. 16, 2012.

(51) Int. Cl. A01K 85/01; B29C 37/00; B29C 35/00

(52) U.S. Cl. CPC A01K 85/01; B29C 35/002; B29C 37/0025; B29L 2031/702

(57) ABSTRACT

A fishing lure comprises a hydrogel material and at least one water soluble attractant. The fishing lure can be a single hydrogel component or can have a core-shell structure having one or more shells on a core, where the shells and core differ by repeating unit composition and/or by the cross-linking density of the shell and core material, wherein the core is more highly cross-linked than the shells. The hydrogel can be cross-linked ionically, covalently, or physically by phase separation of a block copolymer. The fishing lure displays a loss of attractant during use, but the lure can be reloaded by submerging the lure in a solution of or in neat liquid attractant. When the fishing lure has a core-shell structure, an additional attractant that has low water-solubility, such as a lipid or oil, can be infused into the lure.

### CROSS-REFERENCE TO RELATED APPLICATION

The present application claims the benefit of U.S. Provisional Application Ser. No. 61/672,163, filed Jul. 16, 2012, which is hereby incorporated by reference herein in its entirety, including any figures, tables, or drawings.

### BACKGROUND OF INVENTION

The search for improved fishing lures is an ancient enterprise. Claudius Aelianus, a Roman of the third century CE, disclosed fly-fishing for trout and other kinds of sport fishing teaching lures fabricated from feathers, lead, bronze, and wild boar's bristles. Today materials used for the manufacture of fishing lures include metal, wood, cork, and plastic, depending on the type of lure.

Natural fish eggs remain a favorite fishing lure. Their use is bad for the environment and the fish. Throughout the world, female salmon are being harvested for their eggs in order to support the bait fishing of the species. To use the salmon eggs, it is necessary to “cure” the eggs using undesired chemicals that can ultimately harm the rivers and streams where these fish spawn. Therefore, it is desirable to eliminate the harvesting of female salmon by providing an excellent egg substitute.

Numerous attempts have been made to develop artificial fish eggs that have the same consistency, shape, flavor and color as the natural commodity. For example, Mack et al., U.S. Pat. No. 1,045,716, teaches the treatment of tapioca kernels with sweetened water to yield a composition similar to fish spawn. Noxon, U.S. Pat. No. 1,291,614, teaches trout bait comprised of a globule of hydrated tapioca, colored to have the appearance of a salmon egg. Zaragoza, U.S. Pat. No. 4,144,353, teaches artificial fish eggs comprising grapes that have been treated with fish oil to impart fishlike odor. Other compositions of artificial fish eggs include a homogenous gel comprising protein, water and both a toughening and hardening compound, where the protein consists of animal gelatin, animal glue and casein, as taught in Humphreys, U.S. Pat. No. 3,421,899. Stephen et al., U.S. Pat. No. 3,876,803, teaches the manufacture of artificial fish eggs by mixing a gel forming proteinaceous material such as animal glue, fish glue, or fish gelation and water at a temperature above the sol-gel transition temperature of the solution in the absence of a tanning agent. This mixture forms a homogeneous liquid proteinaceous mass then undergoes further treatment to yield a fish bait with a cross-linked exterior surface and a gelatinous body. Radden, U.S. Pat. No. 4,773,181, teaches yarn strands which expand into spherical shapes where a different colored yarn simulates egg nucleus to make them appear natural.

Inoue, U.S. Pat. No. 3,875,302, teaches a fishing bait prepared by forming an aqueous mixture of polyvinyl alcohol and fish powders, minced fish, fish oil or shell fish, and pouring the resultant mixture into a mold, freezing the mixture at temperatures below −5° C., and thawing the frozen mixture in air or water at room temperature. Egg-like bait can be prepared by forming the gelled polyvinyl alcohol around fish oil. Prochnow et al., U.S. Pat. No. 5,827,551, teaches a formulation for delivering fish attractants from a stable water-in-oil emulsion of petrolatum jelly, a water soluble delivery agent, a thickening agent, and a water soluble fish attractant, where the formulation is applied to the exterior surface of artificial lures to permit slow release of attractant into the water from the dissolving formulation. Prochnow, U.S. Pat. No. 5,089,277, teaches a lure comprising a water soluble moldable body having a putty-like consistency capable of being formed about a hook that imparts a controlled rate of dispersion of attractants in water, where the body comprises cellulose ether, polyalkylene glycol, and water.

In spite of all of the effort over the centuries, the search for the ultimate fishing lure remains. Lures that are robust, effective, reusable, and biodegradable remain a target for the sports angler.

### DETAILED DISCLOSURE

Embodiments of the invention are directed toward reinforced hydrogel lures and baits. In an embodiment of the invention the lure has the shape of fish eggs, individually, or as a cluster of eggs. In an embodiment of the invention, the lure comprises a hydrogel and at least one diffusible attractant. In another embodiment of the invention, the lure comprises an inner core that is in a gelled state of a first composition and/or cross-linking density by a shell comprising a second hydrogel that is of a second composition and/or a cross-linking density. In an embodiment of the invention, the lure comprises a hydrogel composite with a reinforcing filler matrix to impart a durability and strength.

Hydrogels are water swollen polymeric networks that retain their basic shape due to cross-linking, but absorb and swell with water. The hydrogels can have a modulus of 1 KPa to 10 MPa and a water content of 20% to about 95%. The cross-linking can be due to covalent cross-linking of a homogeneous water-soluble polymer or physical cross-linking because of phase separation of two dissimilar materials, as in a block copolymer with non-miscible polymeric blocks. The hydrogels can be porous, having pores that can vary from a few nanometers to nearly a micrometer. The hydrogel structure effectively controls the release of attractants from the hydrogel. The attractants can be small molecules, oligomeric compounds, or polymeric materials. For example, the attractants can be compounds that release a “scent”, amino acids, proteins, small organic molecules, or electrolytes that dissolve in water. In an embodiment of the invention, lipids or oils can also be included in the lure if the hydrogel comprises a hydrophobic portion, as in a block copolymer. The attractant is not an organism or any portion of an organism; for example, the attractant is not shrimp, salmon eggs, fish powders, or fish parts. The lures, according to embodiments of the invention, can be reloaded with attractants after use and depletion of the attractants, which diffuse from the lure while fishing. Hydrogels can provide a “slimy” feel, can impart resistance to deformation (stiffness), can impart tear resistance, and allow the permeation of the attractants during fishing.

The lures, according to an embodiment of the invention, further comprise dye particles, either dissolved, bonded to the hydrogel, or as an entrapped particle to provide a desired optical appearance. Where a dye particle is included to impart color, a reinforcing matrix can entrap the particles to retain color and/or impart a visible texture.

In an embodiment of the invention, the lure has a core-shell structure; the core hydrogel has lower water content than the exterior surface layer. The core hydrogel can be soft or hard, depending on the type of lure desired. The core imparts a visibility and a functional shape to attract fish and it must be operable with a hook, snap, leader, or any mechanism to attach the lure to the fishing line. The core can be shaped or contain components to generate a noise, to impart the lure's color, to contain a source of illumination, or to allow modification of its motion during trolling or retrieval after casting of the line.

In an embodiment of the invention, the core material is reinforced by fillers in the form of fibers, meshes, and weaves. The materials may impart designs, patterns, or textures to the lures. The core hydrogel is combined with the filler, such that the filler is dispersed through the entire core hydrogel. The filler is loaded at a sufficient level such that the stresses imposed on the lure while fishing, particularly those stresses imposed by a hook, are borne by the filler or dispersed over the entire core structure to promote retention of the lure on the fishing line.

The shell of a core-shell type lure, according to an embodiment of the invention, is a hydrogel layer. The shell hydrogel can be of a same chemical composition as that of the core hydrogel but differing in cross-linking density and, therefore, differing from the core regarding the degree of swelling, rates of attractant diffusion, and capacity for the attractant. A core-shell type lure that has a gradient of cross-linking densities is constructed by forming a cross-linked hydrogel core, coating the core with a precursor to a like hydrogel and cross-linking the hydrogel, wherein a gradient structure can be formed when the coating and cross-linking steps are repeated one or more additional times. In an embodiment of the invention, the hydrogel can be an interpenetrating network of two or more hydrogels. A core-shell lure can have a shell of a second hydrogel and a core of a first hydrogel interpenetrating with a second hydrogel, wherein the second hydro gel shell is bound to the core by interpenetration with the first hydrogel. The shell need not cover the entire surface of the core hydrogel. For example, the second hydrogel can be formed by dip-coating a portion of the core in a shell precursor that is polymerized or cross-linked on the core where the dip-coated shell precursor was placed. For example, the coverage can be 1 to 100 percent of the core's surface.

In an embodiment of the invention, the hydrogel comprising lure is restorable, reloadable, and reusable, For example, the hydrogel lure can be cleaned with an aqueous hydrogen peroxide solution to remove attractant that has aged and is no longer functional as an attractant. The cleaned hydrogel lure can be reloaded with one or more attractants by soaking the hydrogel lure in a solution of attractant or in a neat liquid attractant.

In an embodiment of the invention, the shell can be a temperature sensitive hydrogel material, such as poly(N-isopropylacrylamide) (poly-NIPAM) gels, which shrink rapidly and dramatically, by about 50% by volume in seconds when immersed in approximately 100° F. water. The ability to cycle the shell's dimensions by temperature facilitates a rapid loading and removal of the attractant. An attractant exchange cycle can be carried out by immersing a used lure in hot water to remove an old attractant, followed by immersing of the shrunken lure in a cold attractant solution to rapidly re-swell the hydrogel with fresh attractant.

In an embodiment of the invention, a lure can be fabricated by combining an aqueous solution comprising 7.5% to 20% acrylamide monomer or 20% to 90% (hydroxyethyl)methacrylate monomer with 0.01% to 5% N,N′-methylenebisacrylamide, 0% to 2% colored powders, dyes, glitters, and/or glow in the dark additives, 0.02% to 0.1% tetramethylethylenediamine, and 0.02% to 0.1% of the initiator, ammonium persulfate, placing the mixture in a mold, and, optionally, warming the mold. In another embodiment of the invention, polyethylene glycol diacrylate (PEG-diacrylate), a macromer, can be crosslinked into a hydrogel by employing the same initiator system as used for acrylamide gels. In an embodiment of the invention, the initiator can be a photoinitiator.

In another embodiment of the invention, sodium or potassium alginate, or a salt of hyaluronic acid can be ionically cross-linked upon mixing with a calcium chloride solution, or can be covalently crosslinked using 1-ethyl-3-[3-dimethylaminopropyl]carbodiimide hydrochloride (EDC) or N-hydroxysulfosuccinimide (Sulfo-NHS) reagents. Advantageously, these carbohydrate based hydrogels are biodegradable when the lure is lost while fishing.

In another embodiment of the invention, a block copolymer hydrogel, for example, a silicone hydrogel similar to those used as extended wear contact lenses, can be used as a lure or as the core of a core-shell lure. Other block copolymer hydrogels can be used. For example, a mono-hydroxy ended polyethylene oxide, a macromer, can be condensed with a cyclic lactide ester to prepare a polyethyleneoxide-block-polylactic acid copolymer that is biodegradable. By controlling the size of the polylactic acid copolymer, a desired durability, and rigidity can be achieved. Alternately, a polyester acetal block ethyleneoxide copolymer, for example, a poly(1,3-dioxolan-4-one)-block-polyethylene oxide polymer, can be prepared to impart biodegradability to the lure.

The attractant is a water-soluble molecule that is sufficiently small in hydrodynamic volume for diffusion from solution into the hydrogel lure upon soaking the lure in an attractant solution. Having a hydrogel structure of low cross-link density, in at least a shell of the lure, allows the surface hydrogel to be of sufficiently water-swellability to incorporate some larger proteins. Block copolymer hydrogels can promote incorporation of large amounts of lipids and/or oils that display very limited water-solubility, a negligible water-solubility, but can constitute attractants that slowly leach from the lures over a relatively long period of time.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

We claim:

1. A fishing lure, comprising a polymeric hydrogel and at least one attractant, wherein attractants have water-solubility.

2. The fishing lure according to claim 1, wherein the polymeric hydrogel comprises a cross-linked polymer comprising acrylamide repeating units, (hydroxyethyl)methacrylate repeating units, (vinyl alcohol) repeating units, ethylene oxide repeating units, alginate repeating units, hyaluronic acid repeating units, N-isopropylacrylamide, acrylic acid repeating units, methacrylic acid repeating units, vinyl pyrrolidone repeating units, ethyleneimine repeating units, or vinyl amine repeating units.

3. The fishing lure according to claim 2, wherein the cross-linked polymer is a covalently cross-linked polymer.

4. The fishing lure according to claim 2, wherein the cross-linked polymer is an ionically cross-linked polymer.

5. The fishing lure according to claim 1, wherein the polymeric hydrogel comprises a block copolymer that is physically cross-linked by phase separation of incompatible polymeric blocks.

6. The fishing lure according to claim 5, wherein the block copolymer is a silicone hydrogel.

7. The fishing lure according to claim 5, wherein the block copolymer comprises a hydrophobic block and a hydrophilic block comprising acrylamide repeating units, (hydroxyethyl)methacrylate repeating units, (vinyl alcohol) repeating units, ethylene oxide repeating units, alginate repeating units, hyaluronic acid repeating units, N-isopropylacrylamide, acrylic acid repeating units, methacrylic acid repeating units, vinyl pyrrolidone repeating units, ethyleneimine repeating units, or vinyl amine repeating units.

8. The fishing lure according to claim 7, wherein the block copolymer comprises a hydrophobic block comprising a biodegradable polymer.

9. The fishing lure according to claim 7, further comprising a second attractant having negligible water-solubility.

10. The fishing lure according to claim 9, wherein the second attractant is a lipid or an oil.

11. The fishing lure according to claim 1, further comprising a reinforcing filler matrix, wherein the filler comprises fibers, a mesh, or a weave.

12. The fishing lure according to claim 11, wherein the fibers, mesh, or weave comprises a non-water soluble polymer, a metal, or a ceramic.

13. The fishing lure according to claim 1, wherein the hydrogel comprises a core and at least one shell of different hydrogel composition.

14. The fishing lure according to claim 13, wherein the core hydrogel composition differs from the shell hydrogel composition by a cross-linking density, wherein the shell's cross-linking density is less than the core's cross-linking density.

15. The fishing lure according to claim 13, wherein the core is a hydrogel of different chemical composition than is the shell hydrogel.

16. The fishing lure according to claim 13, wherein the hydrogel comprises a gradient structure.

17. The fishing lure according to claim 16, wherein the hydrogel has a gradient of cross-linking densities.

18. The fishing lure according to claim 1, further comprising dyes, wherein the dye is dissolved, covalently bonded to repeating units of the hydrogel, or entrapped as particles within the hydrogel.

19. The fishing lure according to claim 1, wherein the attractant is a water soluble amino acid, protein, small organic molecule, or electrolyte.

20. A method of preparing a fishing lure, comprising:
providing a plurality of at least one first monomer and/or at least one first macromer;
providing an attractant;
polymerizing and/or cross-linking the first monomers and/or first macromers in a mold to fowl a core lure;
optionally providing at least one second monomer and/or at least one second macromer and polymerizing and/or cross-linking the second monomer and/or second macromer on the core lure to form a shell of a core-shell lure, wherein the second monomer and/or second macromer are the same as or different than the first monomers and/or first macromers, and wherein the core lure and the shell differ in composition and/or cross-linking density; and
infusing the core or core-shell lure with one or more attractants.

21. The method according to claim 20, further comprising optionally providing at least one third monomer and/or at least one third macromer and polymerizing and/or cross-linking the third monomer and/or third macromer on the core-shell lure to form a second shell of a second core-shell lure, wherein the third monomer and/or third macromer are the same as or different than the second monomers and/or second macromers, and wherein the shell of the core-shell lure and the second shell of the second core-shell lure differ in composition and/or cross-linking density.

22. The method according to claim 20, further comprising combining the at least first monomer and/or at least one first macromer with a reinforcing filler comprising a multiplicity of fibers, a mesh, or a weave.

23. The method according to claim 20, further comprising combining the at least first monomer and/or at least one first macromer with a dye or a dye particle.
